(19) United States
(12) Patent Application Publication
(10) Pub. No.: US 2022/0180904 A1
(43) Pub. Date: Jun. 9, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Masakazu OGAWA, Kanagawa (JP)

(73) Assignee: FUJIFILM Business Innovation Corp., Tokyo (JP)

(21) Appl. No.: 17/337,074

(22) Filed: Jun. 2, 2021

(30) Foreign Application Priority Data
Dec. 3, 2020 (JP) 2020-201012

(51) Int. Cl. G11B 27/10; G06F 3/0484

(52) U.S. Cl. CPC G11B 27/10; G06F 3/0484

(57) ABSTRACT

An information processing apparatus includes a processor configured to: receive, from a user, selection of a person from among persons related to a moving image; and in response to receiving the selection, change a reproduction point in the moving image to a point where the selected person is giving utterance.

### CROSS-REFERENCE TO RELATED APPLICATIONS

This application is based on and claims priority under 35 USC 119 from Japanese Patent Application No. 2020-201012 filed Dec. 3, 2020.

### BACKGROUND

### (i) Technical Field

The present disclosure relates to an information processing apparatus and a non-transitory computer readable medium.

### (ii) Related Art

Japanese Unexamined Patent Application Publication No. 2004-172793 discloses a video reproducing apparatus designed to display, at the side of a caption, the face image of a person uttering words of the caption and thereby to easily recognize who utters the words.

Japanese Patent No. 4765732 discloses a moving image editing apparatus that detects a face on the displayed image on the basis of the position designated by a user, identifies a person present at the designated position, and extracts, as a partial moving image, a scene including the identified person.

### SUMMARY

Aspects of non-limiting embodiments of the present disclosure relate to providing an information processing apparatus and a non-transitory computer readable medium that enable a reproduction point in the moving image to be changed to a point where a person selected by a user is giving utterance.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: receive, from a user, selection of a person from among persons related to a moving image; and in response to receiving the selection, change a reproduction point in the moving image to a point where the selected person is giving utterance.

### BRIEF DESCRIPTION OF THE DRAWINGS

Exemplary embodiments of the present disclosure will be described in detail based on the following figures, wherein:

FIG. 1 is a system diagram illustrating the configuration of a moving-image delivery system in an exemplary embodiment of the present disclosure;

FIG. 2 is a block diagram illustrating the hardware configuration of a delivery server in the exemplary embodiment of the present disclosure;

FIG. 3 is a block diagram illustrating the functional configuration of the delivery server in the exemplary embodiment of the present disclosure;

FIG. 4 is a diagram for explaining the starting point and the end point of each of voices of a corresponding one of persons in the moving image;

FIG. 5 is a flowchart illustrating the outline of a process executed by the delivery server in the exemplary embodiment of the present disclosure;

FIGS. 6A and 6B are each a view illustrating an example of a display screen displayed on a terminal apparatus;

FIGS. 7A and 7B are each a view illustrating an example of a display screen displayed on the terminal apparatus;

FIGS. 8A and 8B are each a view illustrating an example of a display screen displayed on the terminal apparatus;

FIGS. 9A and 9B are each a view illustrating an example of a display screen of the terminal apparatus caused to be displayed by a delivery server in a different exemplary embodiment of the present disclosure;

FIGS. 10A and 10B are each a view illustrating an example of a display screen of the terminal apparatus caused to be displayed by the delivery server in the different exemplary embodiment of the present disclosure;

FIGS. 11A and 11B are each a view illustrating an example of a display screen displayed on the terminal apparatus;

FIGS. 12A and 12B are each a view illustrating an example of a display screen displayed on the terminal apparatus;

FIGS. 13A and 13B are each a view illustrating an example of a display screen displayed on the terminal apparatus;

FIGS. 14A and 14B are each a view illustrating an example of a display screen displayed on the terminal apparatus;

FIGS. 15A and 15B are each a view illustrating an example of a display screen displayed on the terminal apparatus;

FIGS. 16A to 16C are each a view illustrating an example of a display screen displayed on the terminal apparatus; and

FIGS. 17A to 17C are each a view illustrating an example of a display screen displayed on the terminal apparatus.

### DETAILED DESCRIPTION

Exemplary embodiments of the present disclosure will be described in detail with reference to the drawings.

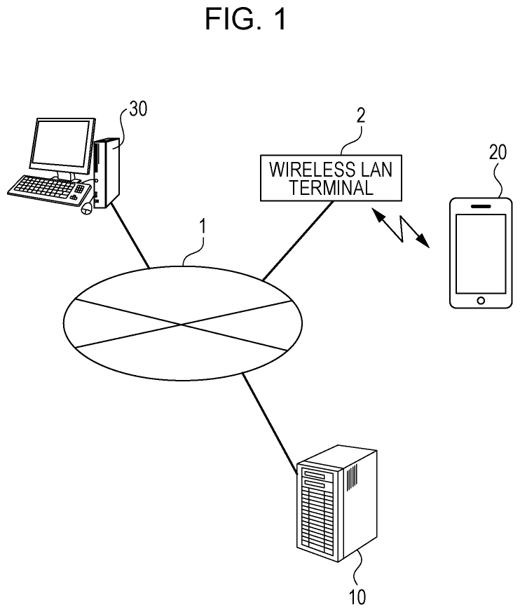

FIG. 1 is a block diagram illustrating the configuration of a moving-image delivery system of an exemplary embodiment of the present disclosure.

As illustrated in FIG. 1, the moving-image delivery system of the exemplary embodiment of the present disclosure includes a delivery server 10, a terminal apparatus 30 such as a personal computer (hereinafter, abbreviated as a PC), a wireless LAN terminal 2, and a terminal apparatus 20 such as a smartphone or a tablet terminal. The delivery server 10, the terminal apparatus 30, and the wireless LAN terminal 2 are mutually connected through a network 1 and are connected to the terminal apparatus 20 via the wireless LAN terminal 2 through a wireless network.

The moving-image delivery system of this exemplary embodiment reproduces a moving image by streaming or downloading moving image data by using the terminal apparatus 20 or 30. The moving image data is stored, for example, in the delivery server 10.

The delivery server 10 is an information processing apparatus on which a program for delivering moving images is installed. The moving images are provided for various pieces of content such as a movie, a drama, an animation, music, and a lecture at the college. The terminal apparatus 20 and the terminal apparatus 30 are each an information processing apparatus that receives a moving image and reproduces the moving image by using the program running on the delivery server 10.

Such a program may be used in such a manner as to be directly installed on the terminal apparatus 20 or 30, without installing the program on the delivery server 10.

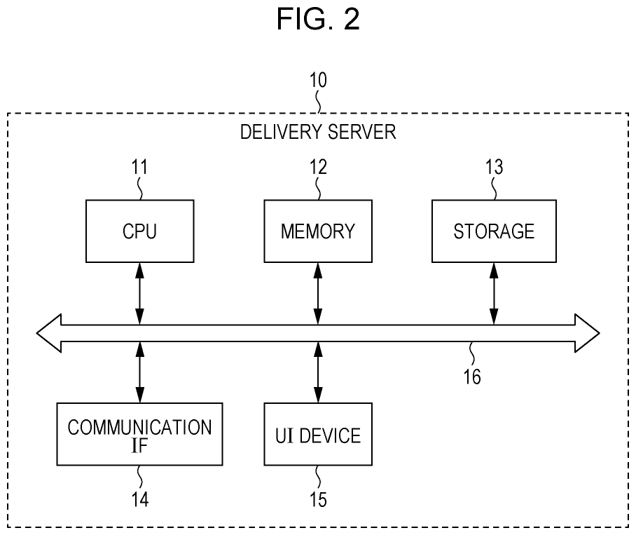

FIG. 2 illustrates the hardware configuration of the delivery server 10 in the moving-image delivery system of this exemplary embodiment.

As illustrated in FIG. 2, the delivery server 10 includes a central processing unit (CPU) 11, a memory 12, a storage 13 such as a hard disk drive (HDD), a communication interface (IF) 14 that transmits and receives data to and from an external apparatus or the like such as the terminal apparatus 20 or 30 via the network 1, and a user interface (UI) device 15 including a touch panel or a liquid crystal display as well as a keyboard. These components are connected to each other via a control bus 16.

The CPU 11 executes a predetermined process in accordance with a control program stored in the memory 12 or the storage 13 and thus controls the operation of the delivery server 10. In the description for this exemplary embodiment, the CPU 11 reads out and runs the control program stored in the memory 12 or the storage 13; however, the program may be stored in a storage medium such as a compact disc-read only memory (CD-ROM) and then may be provided to the CPU 11.

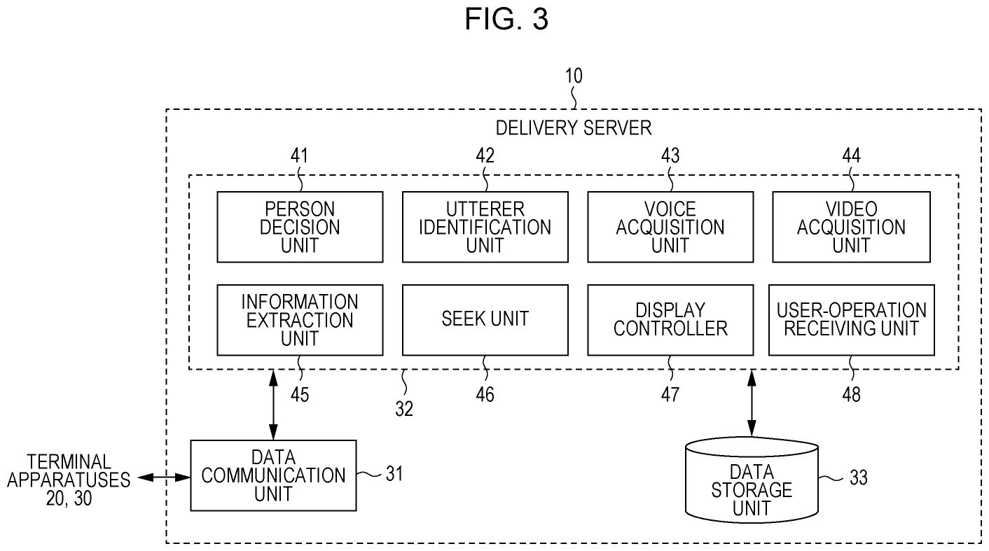

FIG. 3 is a block diagram illustrating the functional configuration of the delivery server 10 implemented by running the control program above.

As illustrated in FIG. 3, the delivery server 10 of this exemplary embodiment includes a data communication unit 31, a controller 32, and a data storage unit 33.

The data communication unit 31 performs data communication with the terminal apparatuses 20 and 30 via the network 1.

The controller 32 controls the operation of the delivery server 10 and includes a person decision unit 41, an utterer identification unit 42, a voice acquisition unit 43, a video acquisition unit 44, an information extraction unit 45, a seek unit 46, a display controller 47, and a user-operation receiving unit 48.

The data storage unit 33 stores various pieces of content data regarding a moving image and the like to be delivered. The data storage unit 33 also stores coordinate points of each of persons at each of reproduction time points in the moving image. The data storage unit 33 also stores information indicating who gives utterance corresponding to a voice included in the moving image. That is, the data storage unit 33 stores the voice included in the moving image and a person giving utterance corresponding to the voice in association with each other. The data storage unit 33 also stores information regarding a person who is not included in the moving image and gives utterance and whose voice is included in the moving image and a person who is included in the moving image and whose voice is not included in the moving image.

A person in the moving image herein includes a character and the like in an animation other than a person. The term “utterance” denotes uttering a language as voice and the voice resulting from the utterance. The term “utterer” denotes a person giving utterance in the moving image and producing a voice.

The display controller 47 controls a screen displayed on the terminal apparatus 20 or 30.

The seek unit 46 reproduces and stops a moving image and changes the reproduction point in the moving image on the display screen of the terminal apparatus 20 or 30.

The user-operation receiving unit 48 receives a part selected by a user with the terminal apparatus 20 or 30. Specifically, the user-operation receiving unit 48 receives the selection of a search target person from among persons related to the moving image during the reproduction of the moving image on the display screen of the terminal apparatus 20 or 30.

The person decision unit 41 decides the search target person after the selection of the person intended for moving the reproduction point to a point of utterance of the person is received from the user. The person is selected from among the persons related to the moving image. In other words, the person decision unit 41 receives the selection of the person received by the user-operation receiving unit 48 and decides the search target person. Specifically, suppose a case where the person decision unit 41 receives the selection of a person from among persons included in the moving image in the terminal apparatus 20 or 30. In this case, based on the coordinate point of the person in the moving image in which the selection is received, the person decision unit 41 decides, as the search target person, the person the selection of which is received. In other words, based on the reproduction time point in the moving image in which the selection of the person is received by the user-operation receiving unit 48 and the coordinate point in the moving image in which the selection of the person is received, the person decision unit 41 decides, as the search target person, the person the selection of which is received.

The utterer identification unit 42 analyzes voice in the moving image data and identifies an utterer who is a person giving utterance.

The voice acquisition unit 43 acquires the starting point and the end point of an utterance given by the person identified by the utterer identification unit 42 in the moving image data. In other words, the voice acquisition unit 43 acquires points where the person decided by the person decision unit 41 is giving utterance and that are respectively the starting point and the end point of the utterance of the person decided by the person decision unit 41.

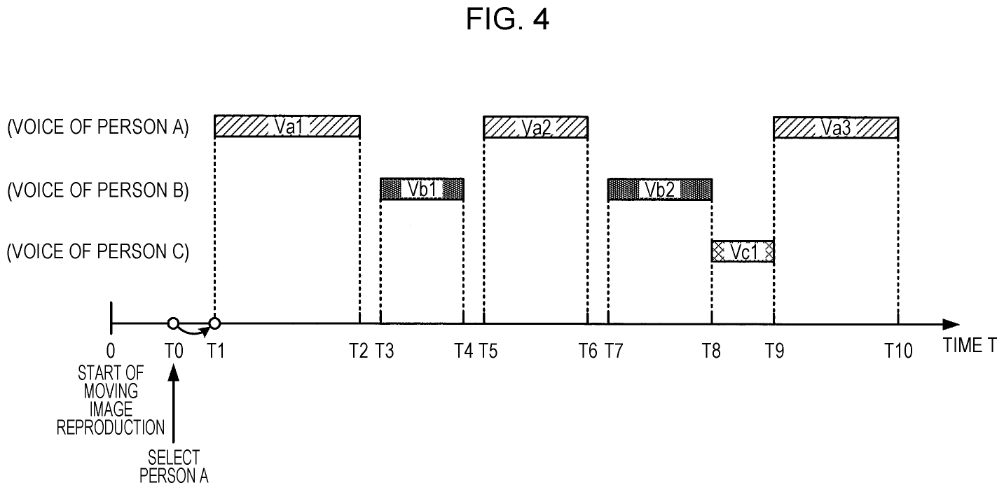

For example, as illustrated in FIG. 4, the voice acquisition unit 43 acquires a starting point T1 and an end point T2 of a voice Va1, a starting point T5 and an end point T6 of a voice Va2, and a starting point T9 and an end point T10 of a voice Va3. The voices Va1, Va2, and Va3 are voices of a person A and utterances given by the person A. The voice acquisition unit 43 also acquires a starting point T3 and an end point T4 of a voice Vb1 and a starting point T7 and an end point T8 of a voice Vb2. The voices Vb1 and Vb2 are voices of a person B and utterances given by the person B. The voice acquisition unit 43 also acquires a starting point T8 and an end point T9 of a voice Vc1 of a person C that is an utterance given by the person C.

The video acquisition unit 44 analyzes video in the moving image, identifies a person included in the moving image, and acquires the starting point and the end point of a scene including the identified person.

The utterer identification unit 42 may identify the utterer from the movement of the mouth on the basis of the video acquired by the video acquisition unit 44. In addition, the voice acquisition unit 43 may acquire the starting point and the end point of the utterance of the person from the movement of the mouth on the basis of the video acquired by the video acquisition unit 44.

The information extraction unit 45 stores, in the data storage unit 33, information regarding a voice from the starting point to the end point of the utterance of the person acquired by the voice acquisition unit 43 and the person acquired by the video acquisition unit 44 in association with each other. The information extraction unit 45 also extracts information regarding a person who is not included in the moving image and whose voice is included in the moving image and information regarding a person who is included in the moving image and whose voice is not included in the moving image and stores the information in the data storage unit 33.

Specifically, the data storage unit 33 associates the voices Va1, Va2, and Va3 with the person A who is the utterer of the voices Va1, Va2, and Va3 and stores the information. The data storage unit 33 also associates the voices Vb1 and Vb2 with the person B who is the utterer of the voices Vb1 and Vb2 and stores the information. The data storage unit 33 also associates the voice Vc1 with the person C who is the utterer of the voice Vc1 and stores the information.

When the person decision unit 41 decides the search target person, the seek unit 46 changes the reproduction point in the moving image to a point where the person decided by the person decision unit 41 is giving utterance, on the basis of the information regarding the voice of the decided person.

Specifically, the seek unit 46 changes the reproduction point in the moving image to a point at which the reproduction of one of the voices of the person selected by the user is started and that corresponds to the starting time of the voice that is later than and closest to the reproduction time at the time point of receiving the selection. If the selection of the person is serially received, the seek unit 46 changes the reproduction point in the moving image to a point at which the reproduction of one of the voices of the serially selected person is started and that corresponds to the starting time of the voice that is later than the reproduction time at a time point of serially receiving the selection. The reproduction point is moved on the basis of the voice of the person by the number of times the person is serially selected. The term “serially select” denotes receiving the selection of the same person with user operations multiple times within a predetermined time period.

For example, as illustrated in FIG. 4, if the person selected by the user is the person A, the seek unit 46 moves the reproduction point in the moving image to the starting point T1 at which the reproduction of the voice Va1 of the voices Va1, Va2, and Va3 of the person A is started and that corresponds to the starting time of the voice Va1 that is later than and closest to a reproduction time T0 at the time point of receiving the selection of the person A. If the person A is serially selected twice at the reproduction time T0 in the moving image, the seek unit 46 moves the reproduction point in the moving image to the starting point T5. At the starting point T5, the reproduction of the voice Va2 of the voices Va1, Va2, and Va3 of the person A serially selected twice is started, and the starting point T5 corresponds to the starting time of the voice Va2 that is later than the reproduction time T0 at the time point of receiving the selection of the person A. The reproduction point is moved on the basis of the voice of the person A by the number of times the person A is serially selected.

If the voice of the person selected by the user is absent in the moving image, the display controller 47 displays a warning indicating that the voice of the person is absent.

If one of the persons related to the moving image is selected, the display controller 47 performs displaying allowing switching of the reproduction point in the moving image to a point where the selected person is giving utterance or to a point where the selected person is present.

The display controller 47 also performs control to display, as pointers, points at which the reproduction of the respective voices of the person selected by the user is started, on the seek bar indicating the reproduction points in the moving image. The seek unit 46 changes the reproduction point in the moving image to a point selected with a user operation from the pointers displayed on the seek bar.

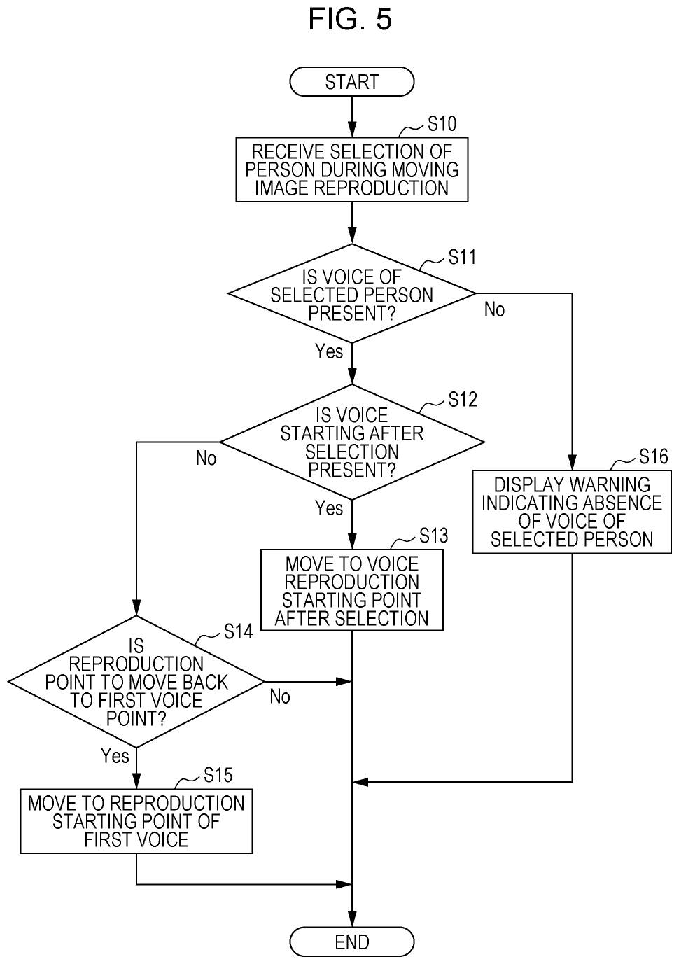

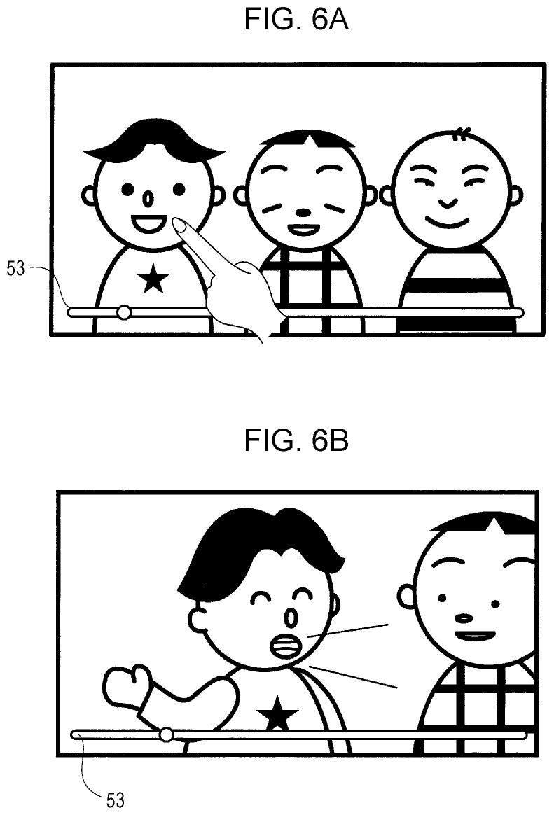

The operation of the delivery server 10 in the moving-image delivery system of this exemplary embodiment will be described in detail with reference to FIGS. 5 to 8B. FIGS. 6A to 8B are each a view illustrating an example of a display screen of the terminal apparatus 20 that receives and reproduces a moving image. On the display screen of the terminal apparatus 20, a seek bar 53 indicating a reproduction point in the moving image is displayed while the moving image is being reproduced.

In step S10, while the moving image is being reproduced, the controller 32 receives a part selected by the user via the user-operation receiving unit 48 and receives the selection of one of persons related to the moving image. If the controller 32 receives the selection of a person included in the moving image reproduced on the terminal apparatus 20 via the user-operation receiving unit 48, the controller 32 causes the person decision unit 41 to decide a search target person on the basis of the coordinate point on the moving image for which the selection is received.

In step S11, the controller 32 then determines whether a voice that is the utterance of the selected person is present in the moving image. In other words, the controller 32 determines whether the voice of the selected person is included in the moving image on the basis of information regarding the voice of the selected person.

If the controller 32 determines in step S11 that the voice of the selected person is present in the moving image, the controller 32 determines in step S12 whether the voice of the selected person starting after receiving the selection of the person is present.

If the controller 32 determines in step S12 that the voice of the selected person starting after receiving the selection of the person is present, the controller 32 causes the seek unit 46 in step S13 to move the reproduction point in the moving image to a point at which the reproduction of one of the voices of the selected person is started and that corresponds to the starting time of the voice that is later than and closest to the reproduction time at the time point of receiving the selection.

Specifically, as illustrated in FIGS. 4, 6A, and 6B, if the user selects the person A included in the reproduced moving image from the display screen of the terminal apparatus 20, the person A serving as the search target person is decided on the basis of the coordinate point of the person A selected by the user in the moving image. Based on information regarding the voice of the person A, the reproduction point in the moving image is then moved to the starting point T1. At the starting point T1, the reproduction of the voice Va1 of the voices Va1, Va2, and Va3 of the person A is started, and the starting point T1 corresponds to the starting time of the voice Va1 that is later than and closest to the reproduction time T0 at the time point of receiving the selection of the person A. The moving image may thus be reproduced with the simple operation from the point T1 where the utterance of the person A starts.

If the controller 32 determines in step S11 that the voice of the selected person is absent in the moving image, the controller 32 causes the display controller 47 in step S16 to display a warning indicating the absence of the voice of the selected person.

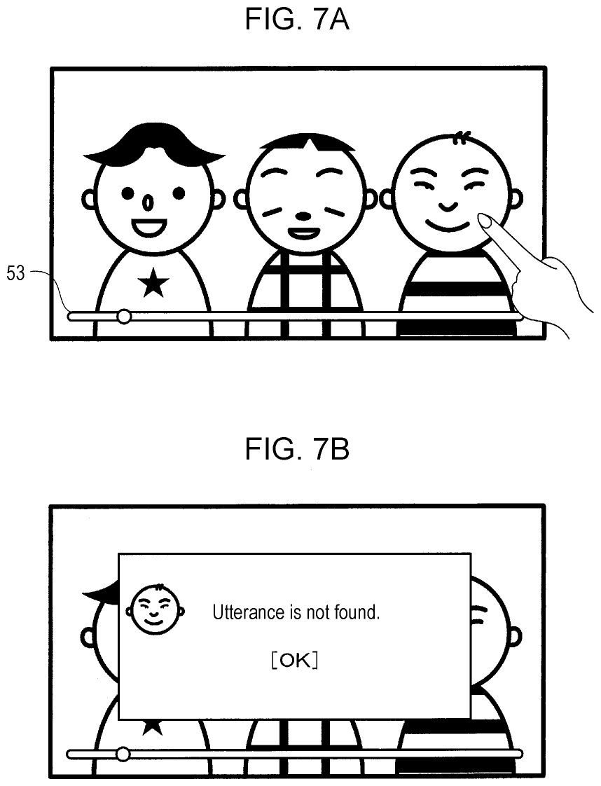

Specifically, as illustrated in FIG. 7A, if the user selects a person D included in the reproduced moving image from the display screen of the terminal apparatus 20, the person D serving as the search target person is decided on the basis of the coordinate point of the person D selected by the user in the moving image. If the voice of the person D is not included in the moving image, the face image of the person D and a message indicating that a voice that is the utterance of the person D is not found are displayed as illustrated in FIG. 7B.

If the controller 32 determines in step S12 that the voice of the selected person starting after receiving the selection of the person is absent, the controller 32 performs control to cause the display controller 47 in step S14 to display a warning indicating that the voice of the selected person after the selection is absent and to display, on the display screen, whether to move the reproduction point in the moving image back to the starting point that is the first utterance point of the first voice of the selected person.

If the controller 32 determines in step S14 that the reproduction point in the moving image is not to be moved back to the first voice of the selected person, the controller 32 terminates the process. That is, the controller 32 does not cause the seek unit 46 to change the reproduction point in the moving image.

If the controller 32 determines in step S14 that the reproduction point in the moving image is to be moved back to the first voice of the selected person, the controller 32 causes the seek unit 46 in step S15 to move the reproduction point in the moving image to the starting point of the first voice of the selected person.

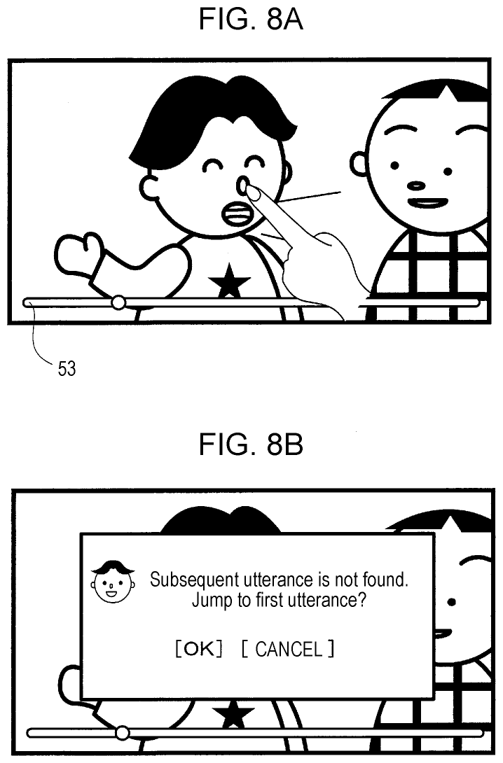

Specifically, as illustrated in FIG. 8A, if the user selects the person A included in the reproduced moving image from the display screen of the terminal apparatus 20, the person A serving as the search target person is decided on the basis of the coordinate point of the person A selected by the user in the moving image. If it is determined that the voice of the person A starting after the reproduction time at the time point of receiving the selection of the person A is absent on the basis of the information regarding the voice of the person A, the face image of the person A, a message indicating that an utterance given after the selection of the person A is not found, and a message for confirming whether to move to the first utterance point of the person A are displayed as illustrated in FIG. 8B. If [CANCEL] is selected on the display screen as illustrated in FIG. 8B, the process is terminated. That is, the reproduction point in the moving image is not changed. If [OK] is selected, the reproduction point in the moving image is changed to the starting point of the first voice that is the first utterance point of the person A. The moving image may thus be reproduced with the simple operation from the starting point of the first utterance of the person A.

The exemplary embodiment in which in response to the user selecting one of the persons included in the moving image, the reproduction point is immediately changed to a point where the selected person is giving utterance has heretofore been described. However, in this exemplary embodiment, if the user performs a misoperation such as selecting a different person in the moving image by mistake, the reproduction point in the moving image is changed to a reproduction point not intended by the user.

To prevent such a misoperation, a candidate person list including a person selected by the user from among the persons included in the moving image may be displayed. The reproduction point in the moving image may thus be changed after the user verifies the person selected from among the persons included in the moving image by using the candidate person list.

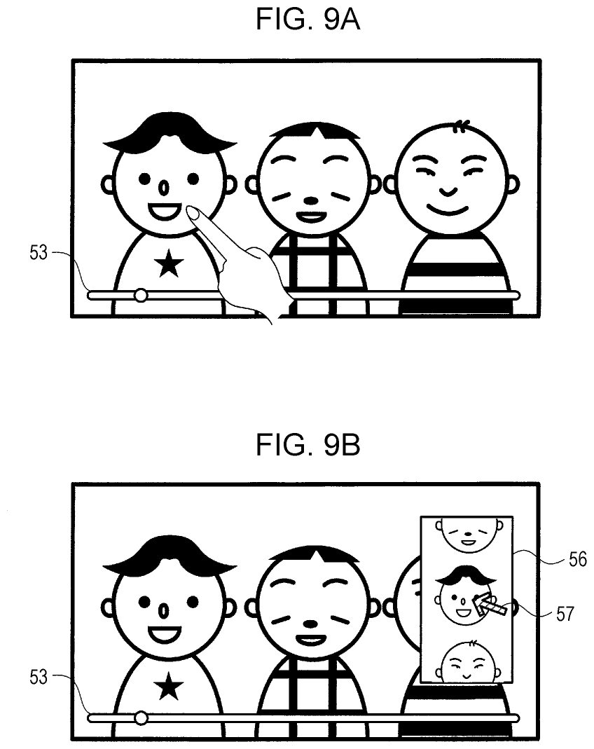

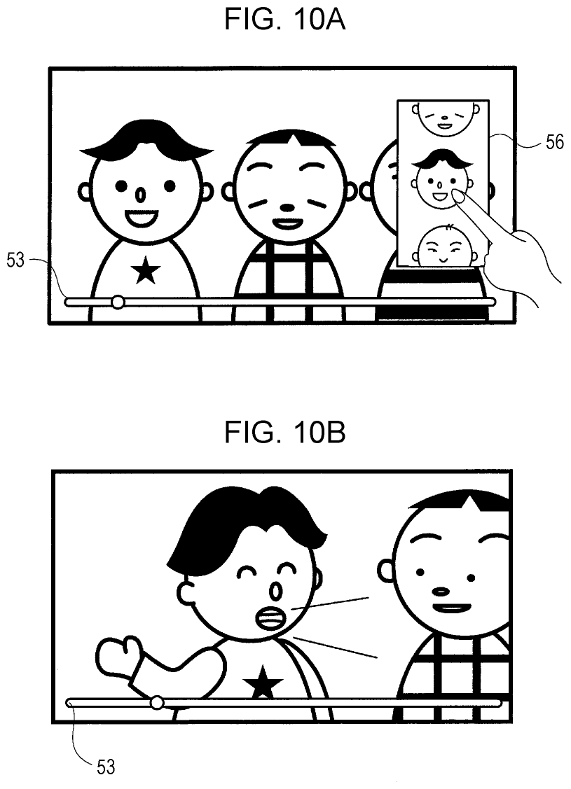

An example of displaying the above-described candidate person list will be described as a different exemplary embodiment of the present disclosure by using FIGS. 9A to 10B. FIGS. 9A to 10B are each a view illustrating an example of a display screen of the terminal apparatus 20 that receives and reproduces a moving image. In this exemplary embodiment, a display controller 67, a user-operation receiving unit 68, and a person decision unit 61 are used in place of the display controller 47, the user-operation receiving unit 48, and the person decision unit 41 in the controller 32 that are described above.

The user-operation receiving unit 68 receives the designation of a search target person of the persons included in the moving image while the moving image is being reproduced on the display screen of the terminal apparatus 20.

The display controller 67 performs control to identify the person designated by the user on the basis of the coordinate point of the designated person in the moving image and to display a candidate person list including the face image of the identified person.

The displayed candidate person list has one or more face images of respective persons included in the moving image. The displayed candidate person list also has one or more face images of respective persons who are not included in the moving image and whose voices are included in the moving image. The reproduction point in the moving image may thus be changed to a point where a person such as a narrator who is not included in the moving image and whose voice is included in the moving image is giving utterance. Note that a mark enabling the face image of the person included in the moving image to be identified may be used for the face image of the person who is not included in the moving image and whose voice is included in the moving image.

If the user designates a person included in the moving image with the terminal apparatus 20, the display controller 67 performs control to display the candidate person list in a state where the designated person is easily selected. For example, if the user designates a person included in the moving image, the display controller 67 performs control to display the face image of the person designated by the user in such a manner that the face image is located in the center of the candidate person list and that an object such as a pointer or a cursor is added to the face image of the person designated by the user. The display controller 67 also performs control to display the face image of a person giving utterance or the mark in the center of the candidate person list in such a manner that the object is added to the face image of the person designated by the user or the mark. The term “object” is a figure or a mark to be operated.

The display controller 67 also performs control to display the face images of the respective persons and the mark in such a manner that the candidate person list on the display screen is vertically scrollable. The user may thus select, from the face images of the respective persons and the mark, the face image of the person or a mark intended for moving the reproduction point in the moving image.

The display controller 67 also performs control to disappear the candidate person list a predetermined time after the start of the displaying the candidate person list.

The person decision unit 61 finally decides, as an actual search target person, a person corresponding to the face image or a mark of the person the selection of which is received by the user-operation receiving unit 68 from the face images of the respective persons and the mark that are displayed in the candidate person list. The person decision unit 61 decides the person intended for moving the reproduction point in the moving image to a point of giving utterance.

The term “designate a person” denotes identifying, by the user, a search target person from persons included in the moving image. In response to the user designating a person in the moving image, a candidate person list including the face image of the person is displayed. The term “select a person” denotes finally deciding a search target person in the candidate person list.

The display controller 67 also performs control to display the candidate person list if a part not including the person in the moving image is designated from the terminal apparatus 20.

The display controller 67 also performs control to display the candidate person list if a person in the moving image who is designated by the user from the terminal apparatus 20 is not determinable.

In this exemplary embodiment, if the user designates the person A included in the reproduced moving image from the display screen of the terminal apparatus 20 as illustrated in FIG. 9A, a candidate person list 56 is displayed. At this time, as illustrated in FIG. 9B, the face image of the person A designated by the user is located in the center of the candidate person list 56, and further the candidate person list 56 is displayed with an object 57 added to the face image of the person A. The user may thereby verify the person designated by the user on the display screen. The user may also select a search target person from the candidate person list 56 with the face images and the like of the respective persons being displayed with user operations of vertically scrolling the candidate person list 56 on the display screen.

If the face image of the person A is selected from the candidate person list 56 as illustrated in FIG. 10A, the person A corresponding to the face image of the selected person A is finally decided as the search target person.

As illustrated in FIG. 10B, the reproduction point in the moving image is then moved to a point at which the reproduction of the voice of the person A is started and that corresponds to the starting time of the voice that is later than and closest to the reproduction time at the time point of receiving the selection of the person A in the candidate person list 56. The moving image may thus be reproduced with the simple operation from the starting point of the utterance of the person A.

A modification of the display screen of the terminal apparatus 20 displayed in the case of using the delivery server 10 in this exemplary embodiment will be described.

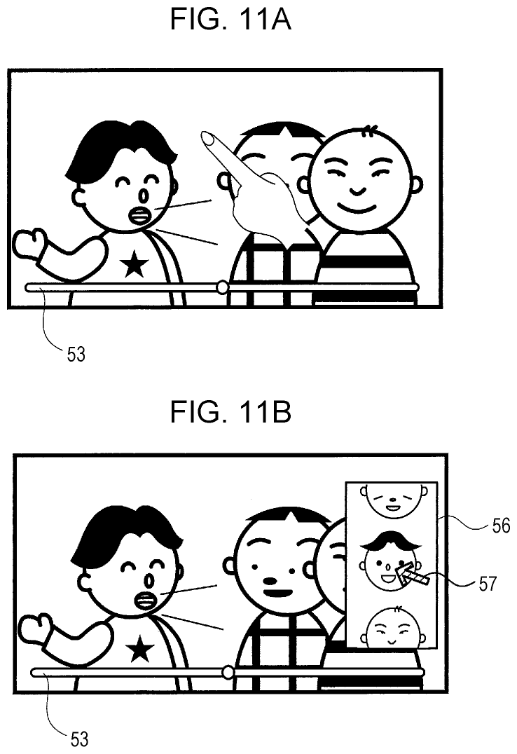

If the user designates a part such as the background not including a person in the moving image from the display screen of the terminal apparatus 20 as illustrated in FIG. 11A, the candidate person list 56 is displayed as illustrated in FIG. 11B. At this time, the face image of the person A giving utterance at the time point of receiving the part not including the person A is located in the center of the candidate person list 56 with the object 57 added to the face image of the person A giving utterance. The candidate person list 56 is displayed in a state where the face image of the person A who is an utterer is easily selected.

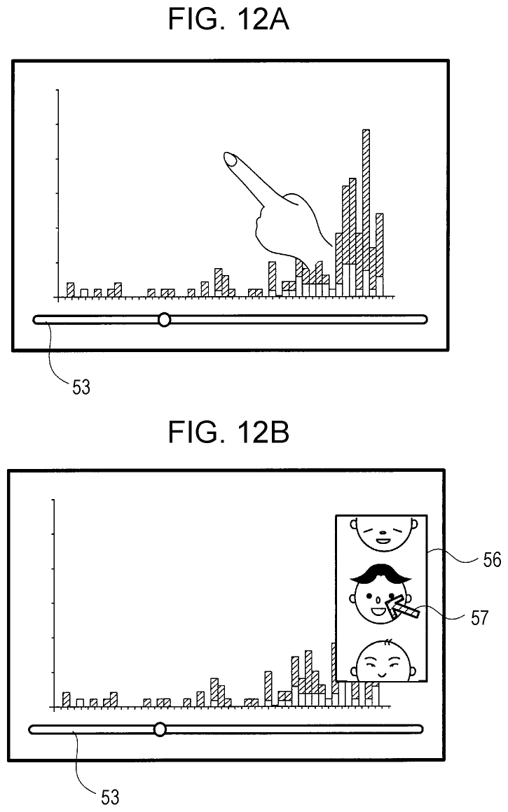

In addition, if the user designates a point in a moving image, for example, that is used in explaining a presentation material or the like and that is displayed on the terminal apparatus 20 as illustrated in FIG. 12A, the face image of the person A who is giving the explanation at the time point of receiving the part not including a person is located in the center of the candidate person list 56, and the candidate person list 56 is displayed with the object 57 added to the face image of the person A giving the explanation as illustrated in FIG. 12B. The candidate person list 56 is displayed in a state where the face image of the person A who is an utterer and is giving the explanation is easily selected.

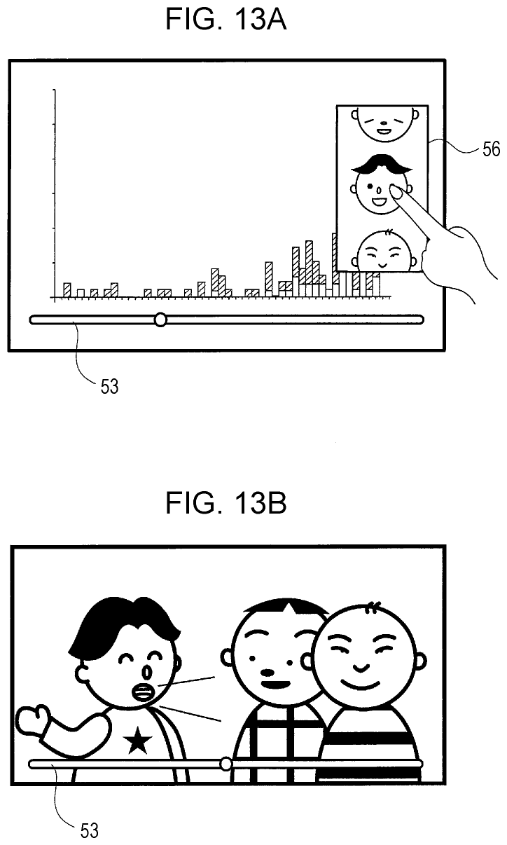

If the user selects the face image of the person A in the candidate person list 56 with the terminal apparatus 20 as illustrated in FIG. 13A, the reproduction point in the moving image is moved, on the basis of the information regarding the voice of the person A as illustrated in FIG. 13B, to a point at which the reproduction of the voice of the person A is started and that corresponds to the starting time of the voice that is later than and closest to the reproduction time at the time point of receiving the selection of the person A. The moving image may thus be reproduced with the simple operation from a point where the next utterance of the person A starts.

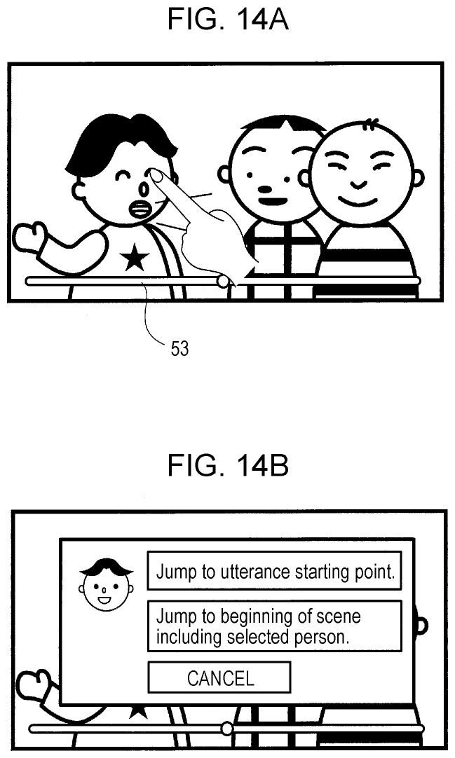

In addition, suppose a case where the user selects the person A included in the moving image with the terminal apparatus 20 as illustrated in FIG. 14A and where the person A is decided as the search target person on the basis of the coordinate point where the person A in the moving image is selected. In this case, as illustrated in FIG. 14B, a selection screen is displayed with the face image of the selected person A being displayed on the basis of the information regarding the voice of the person A. From the selection screen, changing the reproduction point in the moving image to a point where the selected person A is giving utterance or to a point including the selected person A may be selected.

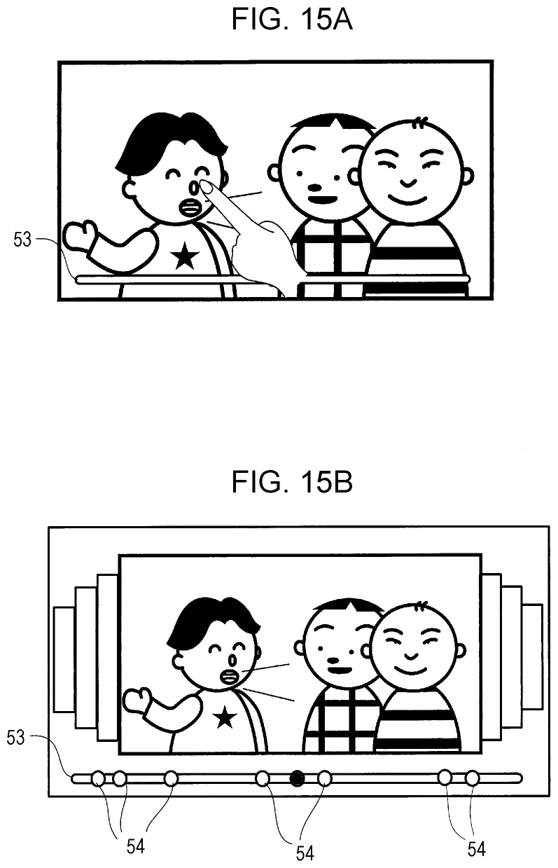

Suppose a case where the user selects the person A included in the moving image with the terminal apparatus 20 as illustrated in FIG. 15A and where the person A in the moving image is decided as the search target person on the basis of the coordinate point where the person A is selected. In this case, as illustrated in FIG. 15B, points where the reproduction of the respective voices of the selected person A in the moving image is started are displayed as pointers 54 on the seek bar 53 on the basis of the information regarding the voices of the person A. In other words, the pointers 54 represent the respective reproduction starting points of the voices of the person A. With user operations in which the screen is horizontally scrolled and the reproduction point is slid on the seek bar 53, the reproduction point in the moving image may be changed to a point selected from among the displayed pointers 54.

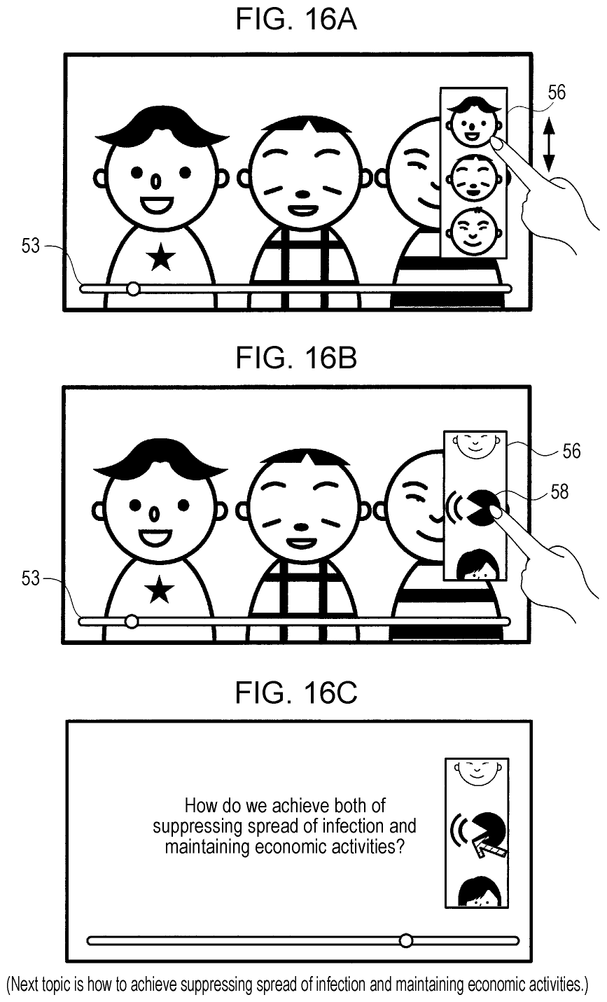

As illustrated in FIGS. 16A to 16C, the user may scroll the candidate person list 56 vertically and thereby select a mark 58 representing a person who is not included in the moving image and whose voice is included in the moving image, from the face images of the respective persons and the like. Based on information regarding the voice of the person corresponding to the mark 58 selected by the user, the reproduction point in the moving image is moved to a point at which the reproduction of one of the voices of the person corresponding to the selected mark 58 is started and that corresponds to the starting time of the voice that is later than and closest to the reproduction time at the time point of receiving the selection of the mark 58. The moving image may thus be reproduced with the simple operation from a point where the utterance of a person not included in the moving image starts. Note that if utterers not identifiable in the moving image are extracted, for example, marks the number of which corresponds to the number of identified utterers are displayed.

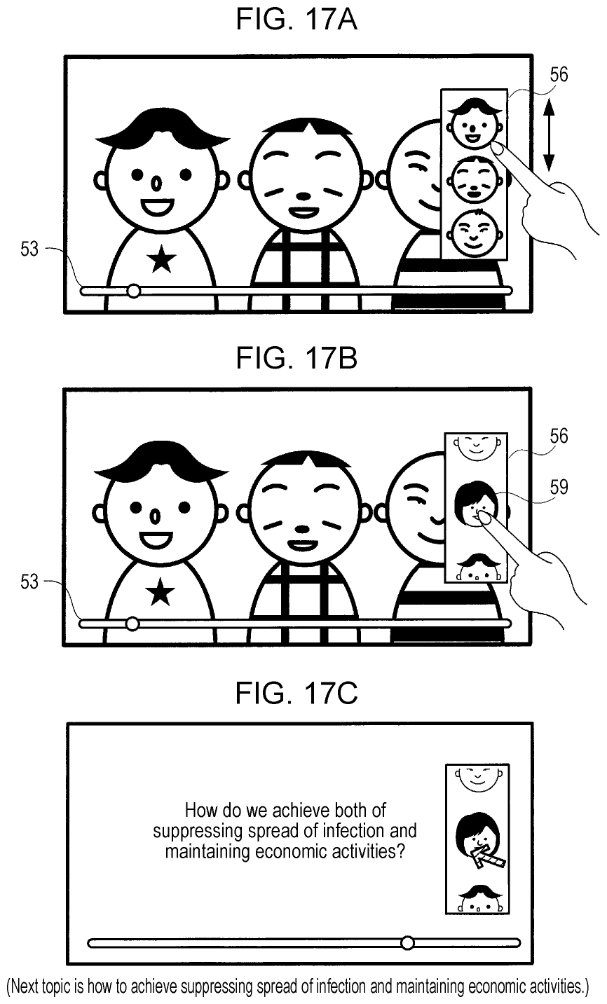

As illustrated in FIGS. 17A to 17C, a face image 59 of a person who is not included in the moving image and whose voice is included in the moving image may be displayed in the candidate person list 56. The face image 59 of the person who is not included in the moving image and whose voice is included in the moving image is displayed on the basis of information regarding a different moving image. In other words, based on information regarding a person or the like who is not included in the moving image but who is included in a different moving image in a series, the face image 59 of the person who is not included in the moving image and whose voice is included in the moving image may be displayed in the candidate person list 56. Based on the information regarding the voice of the person corresponding to the face image 59 of the person selected by the user, the reproduction point in the moving image is moved to a point at which the reproduction of one of the voices of the person corresponding to the face image 59 of the selected person is started and that corresponds to the starting time of the voice that is later than and closest to the reproduction time at the time point of receiving the selection of the face image 59. The moving image may thus be reproduced with the simple operation from a point where the utterance of a person not included in the moving image starts.

The case of using the terminal apparatus 20 to change the reproduction point in the moving image has been described for the exemplary embodiments above; however, the present disclosure is not limited thereto. A case of using the terminal apparatus 30 is likewise applicable.

The case where the seek unit 46 changes the reproduction point in the moving image to a point at which the reproduction of one of the voices of the selected person is started and that corresponds to the starting time of the voice that is later than and closest to the reproduction time at the time point of receiving the selection has been described for the exemplary embodiments above; however, the present disclosure is not limited thereto. The reproduction point in the moving image may be changed to a point at which the reproduction of one of the voices of the selected person is started and that corresponds to the starting time of the voice that is earlier than and closest to the reproduction time at the time point of receiving the selection.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive, from a user, selection of a person from among persons related to a moving image; and
in response to receiving the selection, change a reproduction point in the moving image to a point where the selected person is giving utterance.

2. The information processing apparatus according to claim 1,
wherein the processor is configured to change the reproduction point in the moving image to a point at which reproduction of a voice of voices of the selected person is started and that corresponds to starting time of the voice that is later than and closest to reproduction time at a time point of receiving the selection.

3. The information processing apparatus according to claim 1,
wherein the processor configured to, in response to serially receiving the selection of the person, change the reproduction point in the moving image to a point at which reproduction of a voice of voices of the serially selected person is started and that corresponds to starting time of the voice that is later than reproduction time at a time point of serially receiving the selection, the reproduction point being moved on a basis of the voice of the person by a number of times the person is serially selected.

4. The information processing apparatus according to claim 1,
wherein the processor is configured to, in response to the user designating a person included in the moving image, determine the designated person as the selected person.

5. The information processing apparatus according to claim 2,
wherein the processor is configured to, in response to the user designating a person included in the moving image, determine the designated person as the selected person.

6. The information processing apparatus according to claim 3,
wherein the processor is configured to, in response to the user designating a person included in the moving image, determine the designated person as the selected person.

7. The information processing apparatus according to claim 1,
wherein the processor is configured to:
in response to designating a person included in the moving image, display a candidate person list in a state where the designated person is easily selected; and
receive selection of the person from the candidate person list.

8. The information processing apparatus according to claim 2,
wherein the processor is configured to:
in response to designating a person included in the moving image, display a candidate person list in a state where the designated person is easily selected; and
receive selection of the person from the candidate person list.

9. The information processing apparatus according to claim 3,
wherein the processor is configured to:
in response to designating a person included in the moving image, display a candidate person list in a state where the designated person is easily selected; and
receive selection of the person from the candidate person list.

10. The information processing apparatus according to claim 1,
wherein the processor is configured to:
in response to designating a part not including a person in the moving image, display a candidate person list; and
receive selection of the person from the candidate person list.

11. The information processing apparatus according to claim 2,
wherein the processor is configured to:
in response to designating a part not including a person in the moving image, display a candidate person list; and
receive selection of the person from the candidate person list.

12. The information processing apparatus according to claim 3,
wherein the processor is configured to:
in response to designating a part not including a person in the moving image, display a candidate person list; and
receive selection of the person from the candidate person list.

13. The information processing apparatus according to claim 1,
wherein the processor is configured to:
in response to indeterminableness of designation of a person in the moving image by the user, display a candidate person list; and
receive selection of a person in the moving image from the candidate person list.

14. The information processing apparatus according to claim 2,
wherein the processor is configured to:
in response to indeterminableness of designation of a person in the moving image by the user, display a candidate person list; and
receive selection of a person in the moving image from the candidate person list.

15. The information processing apparatus according to claim 7,
wherein the processor is configured to display, in the candidate person list, the person included in the moving image.

16. The information processing apparatus according to claim 15,
wherein the processor is configured to also display, in the candidate person list, a person who is not included in the moving image and whose voice is included in the moving image.

17. The information processing apparatus according to claim 1,
wherein the processor is configured to, in response to absence of a voice of the selected person in the moving image, display a warning indicating the absence of the voice of the selected person.

18. The information processing apparatus according to claim 1,
wherein the processor is configured to, in response to selecting the person from the persons related to the moving image, perform displaying allowing switching of the reproduction point in the moving image to the point where the selected person is giving utterance or a point where the selected person is present.

19. The information processing apparatus according to claim 1,
wherein the processor is configured to display a plurality of points where reproduction of respective voices of the selected person is started and change the reproduction point in the moving image to a point selected from the plurality of displayed points.

20. A non-transitory computer readable medium storing a program causing a computer to execute a process comprising:
receiving, from a user, selection of a person from among persons related to a moving image; and
in response to receiving the selection, changing a reproduction point in the moving image to a point where the selected person is giving utterance.
